(19) United States
(12) Patent Application Publication
(10) Pub. No.: US 2013/0086775 A1
(43) Pub. Date: Apr. 11, 2013

(54) Closure Assembly Incorporating an Easy Access Tab Integrated into Hook and Loop Fastener Elements and Method for Forming the Same

(71) Applicant: Charles C. Raymond, Mancelona, MI (US)

(72) Inventor: Charles C. Raymond, Mancelona, MI (US)

(21) Appl. No.: 13/644,397

(22) Filed: Oct. 4, 2012

Related U.S. Application Data
(60) Provisional application No. 61/545,353, filed on Oct. 10, 2011.

(51) Int. Cl. A44B 18/00; B32B 38/00; B32B 37/06

(52) U.S. Cl. 24/448; 24/442; 156/73.1

(57) ABSTRACT

An easy access tab integrated into a hook closure forming a portion of overlapping hook and loop engaging surfaces of m adjustable garment An edge extending tab is reverse Folded over and against a forward and central most subset area of the hook surface and is subsequently sonically heat bonded to create a crushed or otherwise smoothed subset surface area maintaining a low profile and without any significant weight addition. The crushed area enables a user to insert one or more digits between the opposing hook and loop configured surfaces of the closure elements to facilitate easier opening and without damaging the closure elements. A corresponding method is also disclosed for sonically heat bonding the reverse, folded tab applied against the hook surface utilizing the above structure.

### CROSS-REFERENCE TO RELATED APPLICATIONS

The present application claims the priority of U.S. Ser. No. 61/545,353 filed Oct. 10, 2011.

### FIELD OF THE INVENTION

The present invention discloses an easy access tab which is integrally defined into selected hook and loop fastener closure elements, such as which are inter-engaged in overlapping fashion in one example associated with an adjustable vest-like garment. The access tab exhibits a crushed subset surface area typically produced by an initial edge extending portion of the tab which is folded over against a forward and central most subset area of the hook surface and subsequently sonically heat bonded to itself as a single layer maintaining a low profile and without any significant weight addition. The crushed area formed within the entryway location of the hook surface enables a user to insert one or more digits (fingers or thumb) between the opposing hook and loop configured surfaces of the opposing closure elements to facilitate easier opening and without damaging the closure elements.

### BACKGROUND OF THE INVENTION

Hook and loop attachment straps are known in the art for use in assisting in opening hook and loop configured closure elements. A problem with such conventional straps, which are typically secured in extending fashion from an edge proximate location of a given one of the closure elements, is that they typically lack any entryway or starting point for initiating controlled and effective “tear away” separation between the closures, this often resulting in damage in the instance of excessive pulling forces being exerted at locations of the closure elements which are not designed to withstand such heavy forces.

Additional attempts have included separating the fabric and webbing tabs to cover the hook teeth in order to create an easier control point, such requiring either thread stitching or glue with the undesirable result being a buildup of material layers with attendant undesirable extra weight.

Other known examples of prior art designs including the tactical shirt for carrying a concealed weapon which is depicted in U.S. Pat. No. 6,986,164 to Morales and which includes a hidden front pocket exhibiting an article supporting cavity accessible from a vertical opening line. A pair of hook and loop patches are provided between the overlaying panel and the shirt, with an opening between the two providing for access to the interior cavity. Disadvantages associated with the Morales construction include its limitation to being used with a cavity enclosure application as well as the use of multiple hook and loop portions (two hook and two loop).

Other secondary references of note include each of the adjustment system for length of a section of a garment (U.S. Pat. No. 6,374,414 to Collier), the no lace shoe with adjustable strap fastening system (U.S. Pat. No. 4,476,639 to Zaccaria) and the surgical gown with pull tab closure (U.S. Pat. No. 4,290,148 to Roberts).

### SUMMARY OF THE INVENTION

As previously described, the present invention discloses an easy access tab integrated into a hook closure forming a portion of overlapping hook and loop engaging surfaces such as are associated with an adjustable vest-like garment or the like. The access tab exhibits a crushed or otherwise smoothed subset surface area typically produced by an initial edge extending portion of the tab which is folded over against a forward and central most subset area of the hook surface and is subsequently sonically heat bonded to itself as a single layer maintaining a low profile (i.e. retaining a thickness approximate to the surrounding region of the hook layer) and without any significant weight addition.

The crushed area formed within the entryway location of the hook surface enables a user to insert one or more digits (fingers or thumb) between the opposing hook and loop configured surfaces of the opposing closure elements to facilitate easier opening and without damaging the closure elements. A corresponding method is also disclosed for sonically heat bonding the reverse folded tab applied against the hook surface utilizing the above structure.

### BRIEF DESCRIPTION OF THE DRAWINGS

Reference will now be made to the attached drawings, when read in combination with the following detailed descriptions wherein like reference numerals refer to like parts throughout the several views, and in which:

FIG. 1 is an environmental perspective of a hook closure element exhibiting the fold-over tab which is sonically heat bonded to create a consistent thickness gripping area relative to the surrounding area of the hook element;

FIG. 2 is an operational perspective depicting a wearer of the garment inserting a pair of digits into the edge proximate access area provided by the tab and in order to provide consistent and controlled “tear-away” separation between the hook and loop closure elements; and

FIG. 3 is a succeeding illustration to that depicted in FIG. 2 and showing the hook closure element in substantially torn away fashion relative to the underlying loop configured surface built into the surface of the vest garment.

### DETAILED DESCRIPTION OF THE PREFERRED EMBODIMENTS

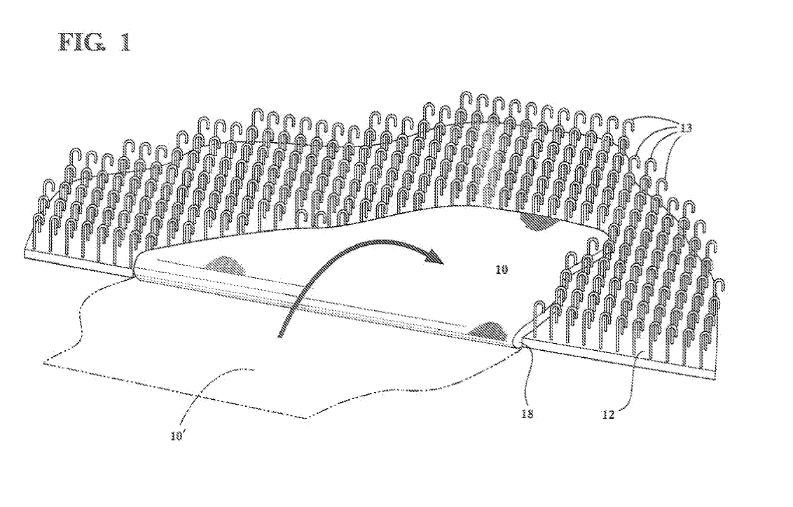

With reference to the illustrations set forth as FIGS. 1-3, the present invention discloses ah easy access tab integrated into a hook closure forming a portion of overlapping hook and loop engaging surfaces such as are associated with an adjustable vest-like garment or the like. FIG. 1 is an environmental perspective of a hook closure element exhibiting the fold-over tab 10 which is sonically heat bonded to create a consistent thickness gripping area relative to the surrounding area of a first closure 12 which depicts a large plurality of hook portions 13 on an inner facing surface.

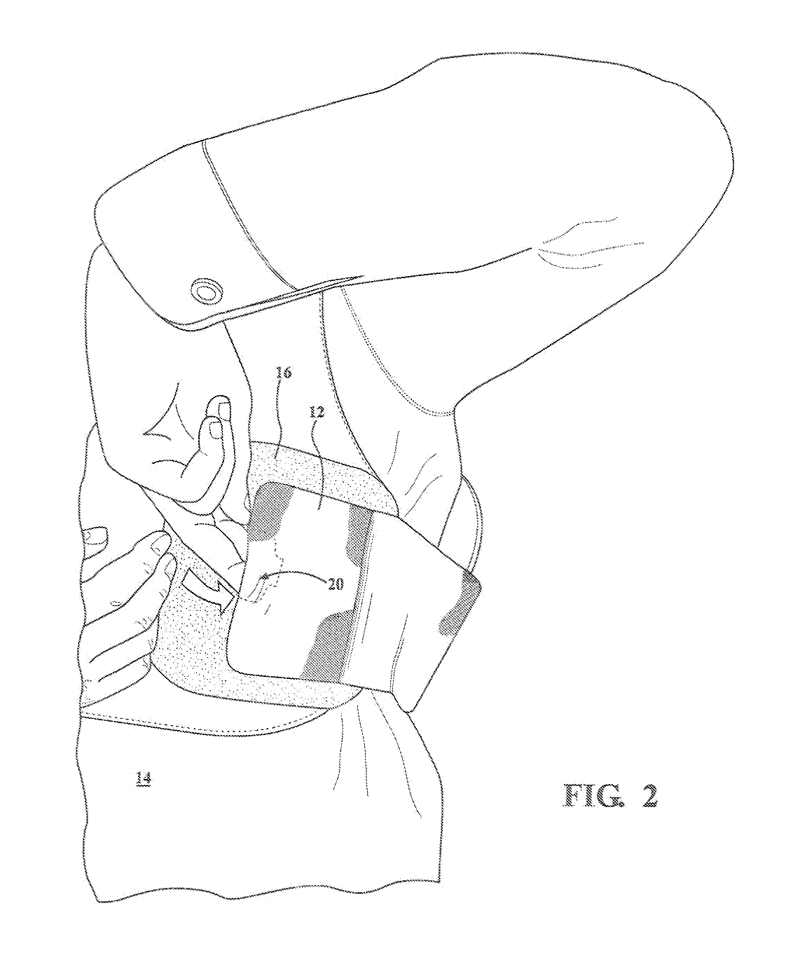

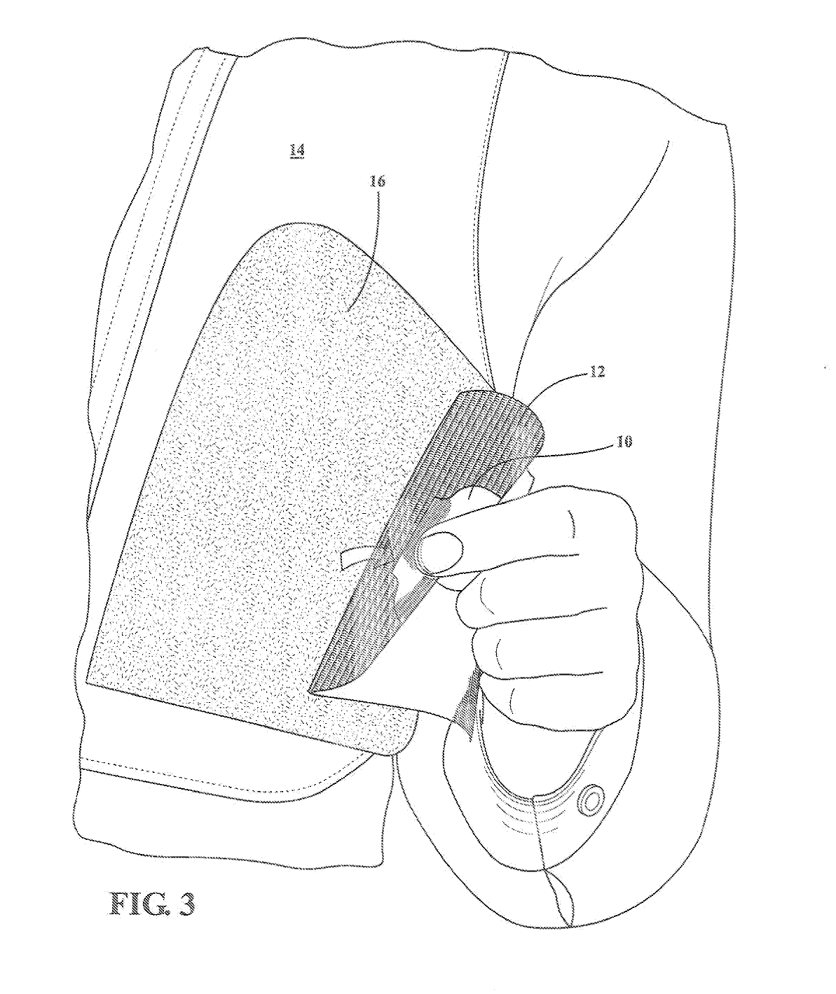

As further depicted in FIGS. 2-3, the hook closure 12 defines an elongated panel (also termed a side strap) which extends from a separated side edge of a vest-like garment 14 (such as a ballistic style vest). The hook closure-panel overlaps and engages, in an adjustable fashion, an underlying loop surfaced panel 16, such as which can be incorporated into a fixed surface location of the garment 14.

The tab as depicted at 10′ in FIG. 1 initially exhibits an initial edge extending portion 18 which is folded over and against a forward and central most subset area of the hook surface of the closure 12, following which the smooth reverse surface of the tab 10 is sonically heat bonded which effectively melts the tab info the overlapped area of the hook closure to define a single integrated layer maintaining a low profile (i.e. retaining a thickness approximate to the surrounding region of the hook layer) and without any significant weight addition.

The crushed area formed within the entryway location of the hook surface enables a user to insert one or more digits (fingers or thumb) between the opposing hook and loop configured surfaces of the opposing closure elements to facilitate easier opening and without damaging the closure elements. A corresponding method is also disclosed for sonically heat bonding the reverse folded tab applied against the hook surface utilizing the above structure.

In this manner, the smoothened access area depicted at 20 in FIG. 2 is created by the tab 10 being folded over and sonically bonded against the underlying central location of fee hook closure 12 and defines an integrated single layer which exhibits a thickness consistent with the surrounding areas of the hook closure 12 and without any significant additional weight.

It has also been found that the ability to avoid employing either a heat press for gluing the area 20, or a sewing machine in order to stitch an extra panel over a corresponding hook exhibiting surface of the closure 12, further results in preserving the integrity, shape and durability of the hooks 13 surrounding the smoothened (sonic heat bonded) area achieved through the article and process of the present invention. Further, and because fee sonic bonded portion is fairly straightforward in construction, it enables easier modification in the creation of an overall tab shaping without fundamentally affecting operation (this including both holding and tear away forces).

A corresponding method of creating a smoothed gripping section associated with an entryway between first and second overlapping closures is also disclosed and includes the steps of providing an edge extending tab wife a first strap extending closure exhibiting a hook surface configuration, reverse folding the tab over and against a forward and central most subset area of the hook surface of the closure, following which the tab is sonically heal bonded against the hook closure so that a smooth reverse surface of the tab is exposed and defines a single integrated layer maintaining a low profile (i.e. retaining a thickness approximate to the surrounding region of the hook layer) and without any significant weight addition.

Having described my invention, other and additional preferred embodiments will become apparent to those skilled in the art to which it pertains, and without deviating from the scope of the appended claims. This can include incorporating other methods for creating the smoothened and digit accessible surface location associated with the hook closure, such as including but not limited to any of incising, shearing or other abrading the subset area 20 depicted in FIG. 3 in order to remove a desired plurality of hooks 13, this in order to create the desired access profile for inserting the wearer's digits and again without the undesirable traits of creating a buildup of material at the separation interface or the attachment of separate panel or other material.

I claim:

1. A closure assembly incorporating an easy access tab which is integrally defined into a hook closure-forming a portion of a wearable garment, said assembly comprising:
the hook closure exhibiting an elongated strap extending from a separated location of the garment, the hook closure exhibiting a plurality of hooks on an inside facing surface;
a tab extending from an extending edge of said hook closure, said tab being reverse folded over and against a forward and central most subset area of the hook defined surface of the closure and compression bonded so that a smooth reverse surface of the tab is exposed and defines a single integrated layer maintaining a low profile; and
an underlying loop surfaced panel incorporated into a fixed surface location of the garment and against which the hook closure strap is affixed such that the smooth tab surface defines an access location for forcible separation of the closures.

2. The closure assembly as described in claim 1, further comprising a sonic heat bonding process for integrating the extending tab in inwardly extending fashion from the extending edge of the hook closure.

3. A method of creating a smoothed gripping section associated with an entryway between first and second overlapping closures, comprising the steps of:
providing an edge extending tab with a first strap extending closure exhibiting a hook surface configuration;
reverse folding the tab over and against a forward and central most subset area of the hook surface of the closure; and
sonically heat bonding the tab against the hook closure so that a smooth reverse surface of the tab is exposed and defines a single integrated layer maintaining a low profile.
